(19) United States
(12) Patent Application Publication
(10) Pub. No.: US 2025/0294426 A1
(43) Pub. Date: Sep. 18, 2025

(54) RADIO LINK FAILURE RECOVERY USING CONDITIONAL HANDOVER

(71) Applicant: MEDIATEK INC., Hsinchu City (TW)

(72) Inventors: Chih-Chuan Cheng, Hsinchu City (TW); Wei-Yu Chen, Hsinchu City (TW); Tsung-Ming Lee, Hsinchu City (TW)

(73) Assignee: MEDIATEK INC., Hsinchu City (TW)

(21) Appl. No.: 19/062,055

(22) Filed: Feb. 25, 2025

Related U.S. Application Data
(60) Provisional application No. 63/565,060, filed on Mar. 14, 2024.

(51) Int. Cl. H04W 36/36; H04B 17/318; H04W 36/00; H04W 36/30

(52) U.S. Cl. CPC H04W 36/362; H04B 17/328; H04W 36/0058; H04W 36/305

(57) ABSTRACT

A method for handling radio link failure (RLF) in a wireless communication system, performed by a user equipment (UE), includes detecting a radio link failure, determining whether a conditional handover (CHO) configuration is present for a target cell, and executing a conditional handover to the target cell regardless of whether conditional handover criteria are satisfied in response to determining the conditional handover configuration being present. The method simplifies the recovery process by eliminating the need for complex measurement verifications during RLF, reducing the time needed for connection recovery.

### CROSS REFERENCE TO RELATED APPLICATIONS

This application claims the benefit of U.S. Provisional Application No. 63/565,060, filed on Mar. 14, 2024. The content of the application is incorporated herein by reference.

### BACKGROUND

Wireless communication systems continue to evolve to meet increasing demands for high-speed data transmission and reliable connectivity. In modern cellular networks, including Long Term Evolution (LTE) and New Radio (NR) systems, maintaining continuous service during user movement requires efficient handover mechanisms between cells. Conditional handover (CHO) was introduced in both LTE and NR systems to improve handover reliability and robustness. In traditional handover procedures, a user equipment (UE) performs measurements on neighboring cells and reports these measurements to its serving cell. The network then makes handover decisions based on these measurement reports. However, this approach can lead to connection failures during rapidly changing radio conditions.

CHO enhances the handover process by allowing the network to configure handover conditions in advance. The UE monitors these conditions through measurement events such as event A3 or A5, which evaluate relative signal strengths between serving and target cells. When these conditions are met, the UE can execute the handover without additional signaling with the network. However, during radio link failure (RLF) scenarios, where the connection between the UE and its serving cell degrades rapidly, the traditional requirement to meet specific handover conditions before executing CHO can lead to unnecessary connection interruptions. This is particularly problematic when the UE has already received CHO configuration for potential target cells but cannot meet the configured criteria due to rapid signal degradation. Therefore, there is a need for improved methods and apparatus for handling radio link failures in wireless communication systems, particularly in scenarios where conditional handover configurations are present but standard handover criteria cannot be met.

### SUMMARY

An embodiment provides a method for handling radio link failure (RLF) in a wireless communication system. The method, performed by a user equipment (UE), comprises detecting a radio link failure, determining whether a conditional handover (CHO) configuration is present for a target cell, and executing a conditional handover to the target cell regardless of whether conditional handover criteria are satisfied in response to determining the conditional handover configuration being present.

An embodiment provides a user equipment (UE) comprising a transceiver and a processor coupled to the transceiver. The transceiver is used to communicate with a wireless communication system. The processor is used to detect a radio link failure, determine whether a conditional handover (CHO) configuration is present for a target cell, and execute a conditional handover to the target cell regardless of whether conditional handover criteria are satisfied in response to determining the conditional handover configuration being present.

In some embodiments, when conditional handover configuration is not present for the target cell, the method comprises performing a radio resource control re-establishment procedure with the target cell. The re-establishment procedure comprises transmitting a radio resource control re-establishment request message to the target cell, receiving a radio resource control re-establishment message from the target cell, and transmitting a radio resource control re-establishment complete message to the target cell.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1A illustrates an exemplary wireless communication system configuration comprising a User Equipment and multiple gNB stations.

FIG. 1B illustrates a session sequence diagram showing an exemplary conditional handover procedure.

FIG. 2 illustrates a flow diagram depicting a method for handling radio link failure scenarios in a wireless communication system according to the embodiments.

### DETAILED DESCRIPTION

This disclosure delves into specific details to provide a comprehensive understanding, but those skilled in the art may practice it without these specifics. Well-known methods, procedures, components, and circuits are not described in detail to maintain clarity. The disclosure primarily focuses on 3GPP wireless networks (4G and 5G), but it can be applied to other cellular or non-cellular wireless networks as well. More specifically, the embodiment of the present specification is mainly described in relation to a 3GPP-based wireless communication system. However, the technical characteristics of the present specification are not limited thereto. For example, the following detailed description is provided based on a mobile communication system corresponding to the 3GPP-based wireless communication system, but aspects of the present specification that are not limited to the 3GPP-based wireless communication system may be applied to other wireless communication systems.

In particular, the following technique, apparatus and system can be applied to various wireless multiple access systems. Examples of multiple access systems include a Code Division Multiple Access (CDMA) system, a Frequency Division Multiple Access (FDMA) system, a Time Division Multiple Access (TDMA) system, an Orthogonal Frequency Division Multiple Access (OFDMA) system, a system, and a Single Frequency Division Multiple Access (SC-FDMA) system. Carrier Frequency Division Multiple Access) systems, and MC-FDMA (Multi-Carrier Frequency Division Multiple Access) systems. CDMA may be implemented through a radio technology such as Universal Terrestrial Radio Access Network (UTRAN) or CDMA2000. TDMA may be implemented through a radio technology such as Global System for Mobile communications (GSM), General Packet Radio Service (GPRS), or Enhanced Data rates for GSM Evolution (EDGE). OFDMA may be implemented through a wireless technology such as Institute of Electrical and Electronics Engineers (IEEE) 802.11 (Wi-Fi), IEEE 802.16 (WiMAX), IEEE 802.20, or Evolved UTRAN (E-UTRAN). UTRAN is part of the Universal Mobile Telecommunications System (UMTS). 3rd Generation Partnership Project (3GPP) Long-Term Evolution (LTE) is a part of Evolved UMTS (E-UMTS) using E-UTRA. 3GPP LTE uses OFDMA in downlink (DL) and SC-FDMA in uplink (UL). Evolution of 3GPP LTE includes LTE-A (Advanced), LTE-A Pro, and/or 5G New Radio (NR).

As described in the standard documents, a Radio Access Network (RAN) provides communication services with external entities through its connection to a core network (CN). For example, E-UTRA may utilize an Evolved Packet Core (EPC), and Next Generation Radio Access Network (NG-RAN) may use 5G Core (5GC). Each RAN may implement one or more radio access technologies (RATs) to perform communication between the base station and the user equipment (UE). For example, the GERAN implements GSM and/or EDGE RAT; the UTRA implements UMTS RAT or other 3GPP RAT; the E-UTRAN implements LTE RAT (sometimes referred to as LTE), and NG-RAN implements NR RAT (sometimes referred to as 5G RAT, 5G NR RAT, or NR). In certain deployments, the E-UTRA may also implement NR RAT. In certain deployments, NG-RAN may also implement LTE RAT.

Furthermore, the RAN can include one or more access nodes that provide wireless coverage, which may be referred to as base stations, NodeBs, evolved NodeBs (eNBs), next Generation NodeBs (gNBs), RAN nodes, or transmission reception points (TRPs). These access nodes can include both ground stations and satellite stations providing coverage within their respective geographic areas. RAN nodes may provide different types of cells including macrocells, picocells, and femtocells. Macrocells typically cover relatively large geographic areas, such as several kilometers in radius, and allow unrestricted access by UEs with service subscriptions. Picocells cover relatively small geographic areas and similarly allow unrestricted access by subscribed UEs. Femtocells serve relatively small geographic areas, such as homes, and may restrict access to specific UEs, such as those in a Closed Subscriber Group (CSG) or UEs associated with users in that location. Different RANs employ specific types of base stations. For instance, an E-UTRAN uses E-UTRAN Node Bs (also known as evolved Node B, enhanced Node B, eNodeB, or eNB) as base stations. Similarly, a Next Generation RAN (NG-RAN) employs next generation Node Bs (also referred to as gNodeB or gNB) as base stations. In 5G networks, gNB can support standalone operations, while various configurations including non-standalone deployments enable interworking between LTE and 5G networks. Each base station type can implement radio protocols specific to its network generation and deployment scenario.

Although not limited thereto, the various descriptions, functions, procedures, suggestions, methods, and/or operation flowcharts disclosed herein may be applied to various fields requiring wireless communication and/or connection (e.g., Wi-Fi, 5G) between devices.

For terms and techniques not specifically described, reference may be made to wireless communication standard documents (e.g., 3GPP Specifications) issued before this specification.

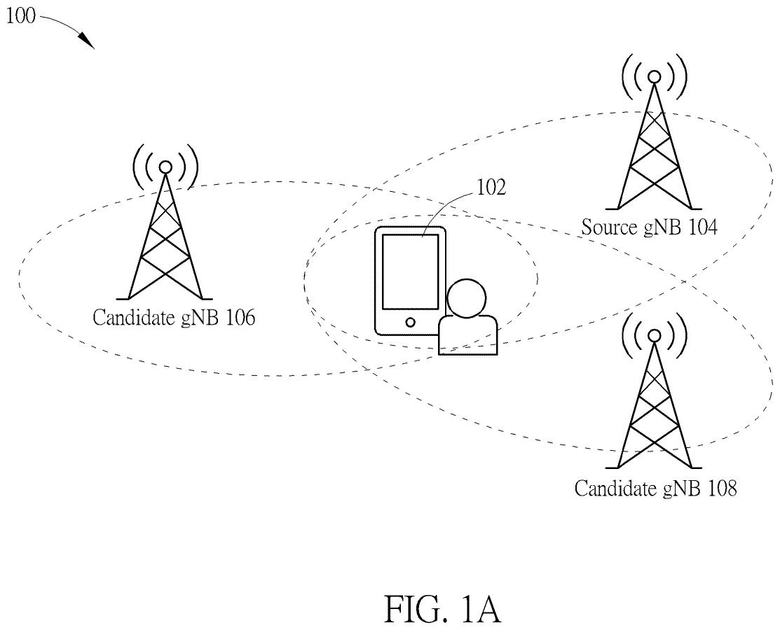

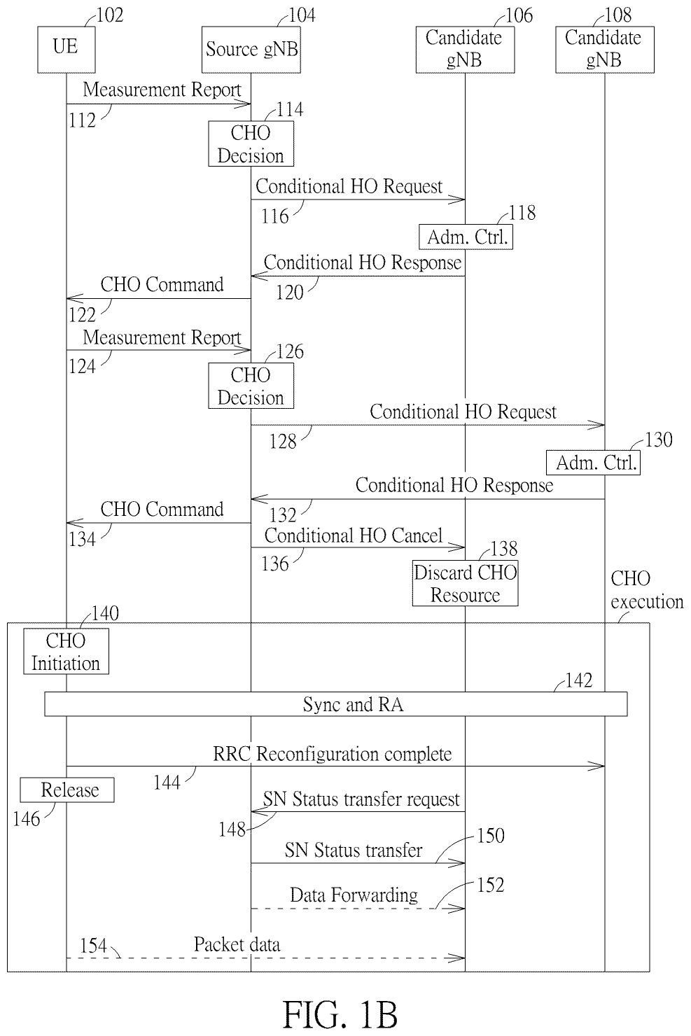

FIG. 1A illustrates an exemplary wireless communication system configuration comprising a User Equipment (UE) 102 and multiple gNB stations. The system includes a source gNB 104 and two candidate gNBs: candidate gNB 106 and candidate gNB 108. Each gNB is represented by a cellular tower symbol with radiating waves, indicating their wireless communication capabilities.

The UE 102 is shown in a position where it can potentially communicate with all three gNBs. The diagram illustrates the coverage areas of each gNB through curved lines surrounding each tower, representing their respective cellular coverage for the UE 102. These overlapping coverage areas demonstrate the potential handover zones where the UE 102 can switch from one gNB to another.

The positioning of the elements suggests a typical cellular network scenario where the UE 102 may need to perform handovers between different cells as it moves within the network coverage area. This arrangement corresponds to the conditional handover (CHO) scenario described in the sequence diagram, where the UE 102 may need to transition between the source gNB 104 and either of the candidate gNBs 106 or 108 depending on various network conditions and measurements.

FIG. 1B illustrates a session sequence diagram showing an exemplary conditional handover procedure. The session sequence diagram illustrates the CHO process between a User Equipment (UE) 102, a source gNB 104, and two candidate gNBs 106 and 108. The sequence begins when the UE 102 transmits a Measurement Report 112 to the source gNB 104. Upon receiving this report, the source gNB 104 performs a CHO Decision 114 and subsequently transmits a conditional HO Request 116 to the first candidate gNB 106. After performing admission control 118, the candidate gNB 106 responds with a conditional HO Response 120.

Following the initial exchange, the source gNB 104 can issue a CHO Command 122 to the UE 102. The UE 102 then transmits another Measurement Report 124, which triggers another CHO Decision 126 by the source gNB 104. This decision initiates a similar exchange with the second candidate gNB 108, comprising a conditional HO request 128, followed by admission control 130, and resulting in a conditional HO response 132.

The source gNB 104 can then proceed to send a CHO command 134 to the UE 102 while simultaneously transmitting a conditional HO cancel 136 to the first candidate gNB 106. This cancellation prompts the candidate gNB 106 to execute a Discard CHO Resource action 138. The UE 102 then commences the CHO Initiation 140, followed by a synchronization and random access (Sync and RA) procedure 142. Upon successful synchronization, the UE 102 transmits an RRC Reconfiguration Complete message 144.

The sequence concludes with a series of network management actions, beginning with Release 146. This is followed by an SN Status Transfer Request 148 and subsequent SN Status Transfer 150. The process finalizes with data forwarding 152 and packet data transmission 154 between the network elements. This comprehensive sequence ensures a coordinated transition of the UE connection from the source gNB to the selected target gNB while maintaining service continuity.

To summarize the above, the CHO procedure, as shown in the sequence diagram and the 3GPP technical specification, begins when the UE sends a Measurement Report to the source gNB, which triggers a CHO Decision and initiates a Conditional HO Request to a first candidate gNB. After admission control, the candidate gNB sends a Conditional HO Response, leading to a CHO Command from the source gNB to the UE. This sequence repeats with a second Measurement Report triggering another CHO Decision, followed by similar exchanges with a second candidate gNB, while the source gNB cancels the conditional handover preparation with the first candidate gNB. The execution phase then begins with CHO Initiation, where the UE performs synchronization and random access procedures with the chosen target gNB, confirmed by an RRC Reconfiguration Complete message. The procedure concludes with a Release message, followed by status transfer procedures between the gNBs (including SN Status Transfer Request and Response), and finally establishes packet data transmission between the UE and the target gNB, completing the handover process.

The traditional conditional handover method faces significant challenges in its implementation and execution. As shown in the sequence diagram, the process requires multiple measurement reports (e.g., measurement reports 112 and 124) and CHO decisions (e.g., CHO decisions 114 and 126), making a complex chain of verification steps that can impede efficient handover execution. The core problem lies in the network's difficulty in verifying whether the UE 102 truly meets the A3 or A5 conditions required for CHO execution. This verification challenge is compounded by the method's resource-intensive nature, where network resources must be allocated to multiple candidate gNBs (e.g., candidate gNBs 106 and 108) and potentially discarded later, as evidenced by the Discard CHO Resource action 138. During Radio Link Failure (RLF) scenarios, this traditional approach becomes particularly problematic as its reliance on strict measurement criteria and multiple decision points (steps 112-132) could lead to connection interruptions while waiting for conditions to be met. The rigidity of requiring specific signal strength measurements before executing handover may not serve the primary goal of maintaining connectivity during emergency scenarios like RLF, where maintaining any connection becomes more critical than meeting ideal signal conditions.

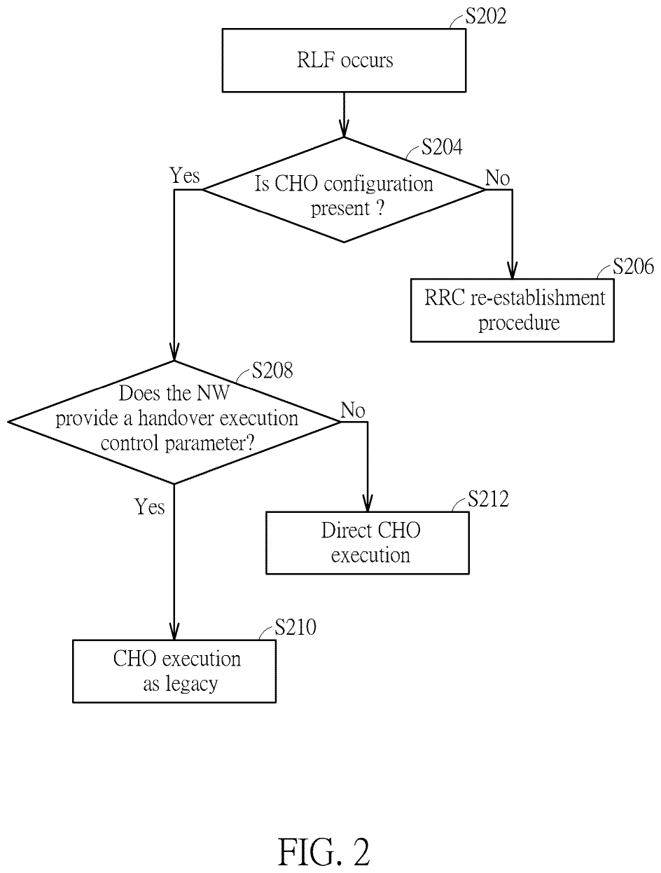

FIG. 2 illustrates a flow diagram depicting a method 200 for handling radio link failure (RLF) scenarios in a wireless communication system according to the embodiments. The process begins at step S202 when a UE (e.g., UE 102) detects an RLF. Note that the RLF can be triggered by T310 timer expiry.

Following the RLF detection, at step S204, the UE checks whether a conditional handover (CHO) configuration is present. If no CHO configuration is present, the process proceeds to step S206, where a standard RRC re-establishment procedure is executed according to according to 3GPP TS 38.331.

If a CHO configuration is present, the process moves to step S208 to check whether the network (NW) provides the handover execution control parameter. Based on this decision, two different CHO execution paths are possible:

In step S210, if the handover execution control parameter is provided (Yes path from S208), the UE may execute CHO as legacy according to the 3GPP technical specification. Conversely, in step S212, if the handover execution control parameter is not provided (No path from S208), the UE may perform CHO execution directly without performing to the standard RRC re-establishment procedure.

A direct CHO execution (S212), as illustrated by the session sequence diagram of FIG. 1B, may begin with UE performing synchronization and random access procedures with the target gNB to establish initial connectivity. Once synchronization is successful, the UE may send an RRC Reconfiguration Complete message to confirm the handover configuration. Following this, a systematic transfer of connection context occurs: the source gNB begins the release process, followed by SN Status Transfer Request and Response between the gNBs to ensure service continuity. The final steps involve establishing data forwarding and packet data transmission through the new connection with the target gNB. This execution procedure is designed to minimize interruption to user services by ensuring a coordinated transition of both control and user plane connections from source to target gNB. The key innovation in this procedure is that it can proceed regardless of whether standard handover criteria are met when radio link failure occurs, thereby improving network reliability during challenging radio conditions.

In certain implementation, the handover execution control parameter may be attemptCondReconfig parameter. The attemptCondReconfig parameter, as described in the 3GPP specification, is a configuration flag that determines how the UE handles CHO during radio link failure scenarios. When this parameter is configured, it indicates whether the UE should attempt to execute a conditional handover based on previously stored configurations when encountering a radio link failure. However, according to the embodiment, the UE can execute CHO regardless of whether attemptCondReconfig is configured or not, which differs from the traditional behavior where the presence or absence of this parameter would determine the handover execution path. The attemptCondReconfig parameter traditionally serves as a network-controlled mechanism to manage whether UEs should attempt conditional reconfigurations during failure scenarios, but in the embodiment checking this parameter can be bypassed to improve connection reliability during radio link failures by allowing direct CHO execution to a configured target cell.

According to the 3GPP technical specification, the RRC reestablishment procedure begins when the UE detects a failure condition, which could be triggered by various scenarios including radio link failure, reconfiguration failures, or integrity check failures. Upon detection, the UE initiates a systematic response by stopping several active timers (such as T310, T312, and T304) and starting a recovery timer T311. During this initial phase, the UE also releases or suspends existing radio configurations to prepare for the reestablishment process.

Following the initial detection, the UE enters a cell selection phase where it searches for and selects a suitable NR cell. Once a suitable cell is found, the UE stops the T311 timer and ensures it has valid and up-to-date system information. This phase is crucial as it determines the target cell for reestablishment. Then procedure involves a three-way message exchange between the UE and the network. First, the UE transmits an RRCReestablishmentRequest message. Upon receiving this request, the network responds with an RRCReestablishment message. The procedure concludes with the UE sending an RRCReestablishmentComplete message, confirming the successful reestablishment of the connection.

In addition, the UE should re-establish its security context, update various security keys, and resume both integrity protection and ciphering for the Signaling Radio Bearer 1 (SRB1). This ensures that the re-established connection maintains the required security standards. The procedure also includes several failure safeguards. If the T311 timer expires during the process, the UE transitions to RRC_IDLE state with a “RRC connection failure” cause. Similarly, if the T301 timer expires or if an integrity check fails, the UE also moves to RRC_IDLE state. For successful completion, the network must verify the UE context, complete security reactivation, and resume SRB1 operations, all while maintaining the original security algorithms.

The embodiments of the present invention provide a significant improvement in handling radio link failures (RLF) during conditional handover scenarios in cellular networks. The innovation allows UEs to execute pre-configured conditional handovers during radio link failure (RLF) without validating conventional signal strength and quality thresholds. This approach solves a critical problem where the network has difficulty verifying if the UE truly satisfies traditional handover conditions during degraded network conditions. The invention simplifies the recovery process by eliminating the need for complex measurement verifications during RLF, reducing the time needed for connection recovery. By allowing direct CHO execution to a prepared target cell during RLF, the invention enhances network reliability and user experience by minimizing connection interruptions that would typically occur in traditional RRC re-establishment procedures. Thus, unlike conventional measurement-dependent methods, this mechanism provides quick connection recovery, significantly improving service continuity during failures.

For clarity in this specification, certain terminological conventions are observed. The singular forms “a”, “an”, and “the” are intended to encompass plural forms as well, unless the context clearly indicates otherwise. The term “and/or” refers to and encompasses any and all possible combinations of one or more of the associated listed items. The terms “includes,” “including,” “comprises,” and “comprising” specify the presence of stated features, integers, steps, operations, elements, and/or components, but do not preclude the presence or addition of one or more other features, integers, steps, operations, elements, components, and/or groups thereof.

The term “exemplary” is used herein to mean “serving as an example, instance, or illustration” and should not be construed as necessarily preferred or advantageous over other aspects or designs.

The use of ordinal designators like “first,” “second,” and so forth in the specification and claims serves to differentiate between multiple instances of similarly named elements. These designators do not imply any inherent sequence, priority, or chronological order in the manufacturing process or functional relationship between elements. Rather, they are employed solely as a means of uniquely identifying and distinguishing between separate instances of elements that share a common name or description.

Unless specifically stated otherwise, the term “some” refers to one or more. Various combinations using “at least one of” or “one or more of” followed by a list (e.g., A, B, or C) should be interpreted to include any combination of the listed items, including individual items and multiple items.

Terms such as “coupled,” “connected,” “connecting,” and “electrically connected” are used synonymously to describe a state of being electrically or electronically linked. When an entity is described as being in “communication” with another entity or entities, it implies the capability of sending and/or receiving electrical signals, which may contain image/voice or data/control information, regardless of whether these signals are analog or digital in nature.

As may be used throughout this specification and the appended claims, terms of approximation and degree such as “substantially,” “approximately,” “generally,” “essentially,” “nearly,” “about,” and similar expressions are used to account for variations in precision, manufacturing tolerances, measurement accuracy, environmental conditions, and inherent material properties that may affect the described features or characteristics. Such variations may range from +20% in broader applications to progressively tighter tolerances of +10%, +5%, +3%, +2%, +1%, or +0.5% in more precise implementations. The specific degree of variation encompassed by these terms of approximation in any given context is informed by the nature of the component, relationship, or parameter being described, the technical requirements of the particular embodiment, and the understanding of one skilled in the relevant art.

In the context of this patent specification, the term “user equipment” (UE) encompasses a broad range of devices possessing radio communication capabilities. This definition includes, but is not limited to, smartphones (specifically, handheld touchscreen mobile computing devices capable of connecting to one or more cellular networks), Personal Data Assistants (PDAs), pagers, laptop computers, desktop computers, wireless handsets, and any computing device equipped with a wireless communications interface. User equipment may also be referred to by various alternative terms, including but not limited to: client, mobile device, mobile terminal, user terminal, mobile unit, mobile station, mobile user, subscriber, user, remote station, access agent, user agent, receiver, radio equipment, reconfigurable radio equipment, or reconfigurable mobile device. These terms should be considered interchangeable within the context of this document.

The scope of UEs also extends to Internet of Things (IoT) devices. IoT UEs are characterized by a network access layer specifically designed for low-power IoT applications that typically involve short-lived UE connections. These IoT UEs may employ various technologies for data exchange, including Machine-to-Machine (M2M), Machine Type Communication (MTC), or massive MTC (mMTC). Such data exchanges may occur with an MTC server or device via a Public Land Mobile Network (PLMN), with other UEs using Proximity Services (ProSe) or Device-to-Device (D2D) communications, or through sensor networks or IoT networks. It is noteworthy that M2M or MTC data exchanges are often initiated by the machine itself rather than by human intervention.

An IoT network, as referenced in the above section, describes an interconnected system of IoT UEs. These UEs may include uniquely identifiable embedded computing devices integrated within the broader Internet infrastructure. IoT UEs may execute background applications, such as keep-alive messages or status updates, to maintain and facilitate the connections within the IoT network.

UEs are configured to establish communicative coupling with Radio Access Networks (RANs) through a radio interface. This radio interface is a physical communication interface or layer designed to operate with various cellular communication protocols. These protocols may include, but are not limited to, Global System for Mobile Communications (GSM) protocol, Code Division Multiple Access (CDMA) network protocol, Push-to-Talk (PTT) protocol, PTT over Cellular (POC) protocol, Universal Mobile Telecommunications System (UMTS) protocol, 3rd Generation Partnership Project Long-Term Evolution (3GPP LTE) protocol, 5G protocol, and New Radio (NR) protocol.

As a specific example, a UE and a RAN may utilize a Uu interface (such as an LTE-Uu interface) to exchange control plane data. This exchange occurs via a protocol stack comprising multiple layers: a Physical (PHY) layer, a Medium Access Control (MAC) layer, a Radio Link Control (RLC) layer, a Packet Data Convergence Protocol (PDCP) layer, and a Radio Resource Control (RRC) layer. In this context, a Downlink (DL) transmission refers to data sent from the RAN to the UE, while an Uplink (UL) transmission refers to data sent from the UE to the RAN.

Furthermore, UEs may employ a sidelink for direct communication with other UEs, facilitating D2D, Peer-to-Peer (P2P), and/or ProSe communication. A ProSe interface, for instance, may incorporate one or more logical channels. These channels include, but are not limited to, a Physical Sidelink Control Channel (PSCCH), a Physical Sidelink Shared Channel (PSSCH), a Physical Sidelink Discovery Channel (PSDCH), and a Physical Sidelink Broadcast Channel (PSBCH).

The various aspects described herein may be implemented using a variety of hardware and software components. These may include processors, Digital Signal Processors (DSPs), Application Specific Integrated Circuits (ASICs), Field Programmable Gate Arrays (FPGAs) or other programmable logic devices, discrete gates or transistor logic, or discrete hardware components. A processor in this context may be a microprocessor, but could also be any conventional processor, controller, microcontroller, or state machine. Processors may also be implemented as combinations of computing devices, such as a combination of a DSP and a microprocessor, multiple microprocessors, one or more microprocessors in conjunction with a DSP core, or any other such configuration.

The aspects described in this specification can be implemented through both hardware and software instructions. These instructions may be stored on various types of computer-readable media, including but not limited to Random Access Memory (RAM), flash memory, Read Only Memory (ROM), Electrically Programmable ROM (EPROM), Electrically Erasable Programmable ROM (EEPROM), registers, hard disks, removable disks, CD-ROMs, or any other form of storage medium known in the art. In a typical configuration, the storage medium is connected to a processor, enabling the processor to read information from and write information to the medium. In some configurations, the storage medium may be integral to the processor itself.

In some embodiments, the computing instructions may be executed by an operating system, which may include but is not limited to Microsoft Windows, Apple Mac OS X, macOS or iOS, various distributions of the Linux operating system, or Google Android operating system.

Some embodiments may involve computers on a distributed computing network, such as a network with multiple clients and/or servers. In such embodiments, clients may run software implementing client-side portions of the described systems and methods, while servers handle requests from these clients. Communication between clients and servers may occur via one or more electronic networks, which may include the Internet, wide area networks, mobile telephone networks, wireless networks (e.g., Wi-Fi, 5G), or local area networks, implemented using any known network protocols.

In implementations where the systems described in this specification collect user information, provisions may be made to protect user privacy and data. Specifically, users may be afforded the opportunity to opt in or out of programs or features that collect personal information, such as data related to user preferences or smart device usage patterns. Furthermore, in certain embodiments, data protection measures may be implemented to anonymize collected information prior to storage or utilization. For instance, a user's identity may be anonymized to prevent the determination or association of personally identifiable information with that specific user. Additionally, user preferences and interaction data may be generalized, potentially based on broader demographic categories, rather than being linked to individual users.

It should be noted that the operational steps described in any exemplary aspects within this specification are provided as examples and for discussion purposes. These operations may be performed in numerous different sequences other than the illustrated sequences. Furthermore, operations described in a single step may actually be performed as multiple distinct steps, and multiple steps may be combined into a single operational step. The steps in the appended figures may be subject to numerous modifications as will be apparent to those skilled in the art.

Some embodiments may incorporate all explicitly disclosed features as well as additional features that, while not specifically described herein, are compatible with and enhance the core invention. Conversely, other embodiments may selectively omit certain non-disclosed elements, either partially or in their entirety, while still falling within the scope of the invention. This flexibility in feature inclusion or exclusion allows for a range of implementations tailored to specific applications or requirements, without departing from the fundamental principles of the invention.

The logical stages illustrated in the drawings may be reordered, combined, or broken out if they are not order-dependent. The ordering and groupings presented in this specification are not exhaustive, and other arrangements will be apparent to those skilled in the art. These stages may be implemented in hardware, firmware, software, or any combination thereof.

The drawings and descriptions provided in this specification offer detailed illustrations of various embodiments of the invention. However, it should be understood by those skilled in the art that these embodiments can be implemented without necessarily adhering to every specific detail provided herein. In some instances, well-established methods, procedures, components, and circuits have been mentioned without elaborate explanations to avoid obscuring the key aspects of the embodiments. It is important to note that the figures presented in this specification, including any component diagrams, are intended for illustrative purposes and may not be drawn to scale. This allows for a clear presentation of the inventive concepts while leaving room for variations and adaptations within the scope of the invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for handling radio link failure (RLF) in a wireless communication system, the method comprising:
detecting, by a user equipment (UE), a radio link failure;
determining, by the UE, whether a conditional handover (CHO) configuration is present for a target cell; and
executing, by the UE, a conditional handover to the target cell regardless of whether conditional handover criteria are satisfied in response to determining the conditional handover configuration being present.

2. The method of claim 1, wherein the conditional handover criteria comprise a time-to-trigger evaluation and/or a reference signal received power (RSRP) threshold.

3. The method of claim 1, further comprising:
performing a radio resource control re-establishment procedure with the target cell in response to determining conditional handover configuration not being present for the target cell.

4. The method of claim 3, wherein performing the radio resource control re-establishment procedure comprises:
transmitting a radio resource control re-establishment request message to the target cell;
receiving a radio resource control re-establishment message from the target cell; and
transmitting a radio resource control re-establishment complete message to the target cell.

5. The method of claim 1, wherein the radio link failure is triggered by expiry of a timer.

6. The method of claim 1, wherein executing the conditional handover comprises:
initiating a synchronization procedure with the target cell; and
transmitting a radio resource control reconfiguration complete message to the target cell.

7. The method of claim 1, further comprising:
monitoring, by the UE, signal quality of a source cell and candidate cells according to a configured measurement event; and
transmitting, by the UE, measurement reports to the source cell based on the signal quality.

8. The method of claim 1, wherein executing the conditional handover comprises executing the conditional handover regardless of whether a handover execution control parameter is provided.

9. The method of claim 1, further comprising:
determining a plurality of target cells having conditional handover configurations; and
selecting one of the plurality of target cells based on respective signal qualities of the plurality of target cells.

10. The method of claim 1, wherein detecting the radio link failure comprises at least one of:
detecting that a signal strength of a neighboring cell becomes offset better than a signal strength of a serving cell; and
detecting that the signal strength of the serving cell becomes worse than a first threshold while the signal strength of the neighboring cell becomes better than a second threshold.

11. A user equipment (UE) comprising:
a transceiver configured to communicate with a wireless communication system; and
a processor coupled to the transceiver, configured to:
detect a radio link failure;
determine whether a conditional handover (CHO) configuration is present for a target cell; and
execute a conditional handover to the target cell regardless of whether conditional handover criteria are satisfied in response to determining the conditional handover configuration being present.

12. The UE of claim 11, wherein the conditional handover criteria comprise a time-to-trigger evaluation and/or a reference signal received power (RSRP) threshold.

13. The UE of claim 11, wherein the processor is further configured to:
perform a radio resource control re-establishment procedure with the target cell in response to determining conditional handover configuration not being present for the target cell.

14. The UE of claim 13, wherein the processor is further configured to:
control the transceiver to transmit a radio resource control re-establishment request message to the target cell;
control the transceiver to receive a radio resource control re-establishment message from the target cell; and
control the transceiver to transmit a radio resource control re-establishment complete message to the target cell.

15. The UE of claim 11, wherein the radio link failure is triggered by expiry of a timer.

16. The UE of claim 11, wherein the processor is further configured to:
initiate a synchronization procedure with the target cell; and
control the transceiver to transmit a radio resource control reconfiguration complete message to the target cell.

17. The UE of claim 11, wherein the processor is further configured to:
monitor signal quality of a source cell and candidate cells according to a configured measurement event; and
transmitting measurement reports to the source cell based on the signal quality.

18. The UE of claim 11, wherein to execute the conditional handover, the processor is configured to execute the conditional handover regardless of whether a handover execution control parameter is provided.

19. The UE of claim 11, wherein the processor is further configured to:
determine a plurality of target cells having conditional handover configurations; and
select one of the plurality of target cells based on respective signal qualities of the plurality of target cells.

20. The UE of claim 11, wherein the processor is further configured to perform at least one of:
detecting that a signal strength of a neighboring cell becomes offset better than a signal strength of a serving cell; and
detecting that the signal strength of the serving cell becomes worse than a first threshold while the signal strength of the neighboring cell becomes better than a second threshold.
